(19) United States
(12) Patent Application Publication
(10) Pub. No.: US 2002/0184490 A1
(43) Pub. Date: Dec. 5, 2002

(54) Anti-piracy network storage device

(75) Inventors: Steven H. McCown, Brighton, CO (US); Stephen S. Selkirk, Broomfield, CO (US); Thomas Nelson Noland, Louisville, CO (US); Michael L. Leonhardt, Longmont, CO (US); Charles A. Milligan, Golden, CO (US)

Correspondence Address: Wayne P. Bailey, Storage Technology Corporation, One StorageTek Drive, Louisville, CO, 80028-4309, US

(73) Assignee: Storage Technology Corporation

(21) Appl. No.: 09/874,649

(22) Filed: Jun. 5, 2001

(51) Int. Cl. H04L 9/00

(52) U.S. Cl. 713/155

(57) ABSTRACT

A method, computer program product, and data storage device for directly downloading data (including audio or video data) from a server in a network to a network-connected storage device is disclosed. The invention prevents piracy of copyrighted data by bypassing any unencrypted transmission to a computer system. A computer sends a request to a server to download the particular data to a particular storage device. The server contacts the storage device directly through the network to initiate the transfer. The server and storage device communicate over an encrypted data channel so as to prevent any third party, including the aforementioned computer, from intercepting and storing the transmitted data.

### BACKGROUND OF THE INVENTION

1. Technical Field

The present invention is directed toward the downloading of data from a network. More specifically, the present invention is directed toward a storage device, data processing system, method, and computer program product for downloading data from a network while preventing piracy of copyrighted material once downloaded.

2. Description of Related Art

Internet, also referred to as an “internetwork”, in communications is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. Operating costs may be reduced by providing informational guides and/or searchable databases of public records online.

Currently, the most commonly employed method of transferring data over the Internet is to employ the World Wide Web environment, also called simply “the web”. Other Internet resources exist for transferring information, such as File Transfer Protocol (FTP) and Gopher, but have not achieved the popularity of the web. In the web environment, servers and clients effect data transaction using the Hypertext Transfer Protocol (HTTP), a known protocol for handling the transfer of various data files (e.g., text, still graphic images, audio, motion video, etc.). Information is formatted for presentation to a user by a standard page description language, the Hypertext Markup Language (HTML). In addition to basic presentation formatting, HTML allows developers to specify “links” to other web resources identified by a Uniform Resource Locator (URL). A URL is a special syntax identifier defining a communications path to specific information. Each logical block of information accessible to a client, called a “page” or a “web page”, is identified by a URL. The URL provides a universal, consistent method for finding and accessing this information by the web “browser”. A browser is a program capable of submitting a request for information identified by a URL at the client machine. Retrieval of information on the web is generally accomplished with an HTML-compatible browser, such as, for example, Netscape Communicator, which is available from Netscape Communications Corporation.

When a user desires to retrieve a document, such as a web page, a request is submitted to a server connected to a client computer at which the user is located and may be handled by a series of servers to effect retrieval of the requested information. The selection of a document is typically performed by the user's selecting a hypertext link. The hypertext link is typically displayed by the browser on a client as a highlighted word or phrase within the document being viewed with the browser. The browser then issues a hypertext transfer protocol (HTTP) request for the requested documents to the server identified by the requested document's URL. The server then returns the requested document to the client browser using the HTTP. The information in the document is provided to the client formatted according to HTML. Typically, browsers on personal computers (PCs) along with workstations are typically used to access the Internet. The standard HTML syntax of Web pages and the standard communication protocol (HTTP) supported by the World Wide Web guarantee that any browser can communicate with any web server.

Among the types of data that may be retrieved from the Internet are audio or music files such as MP3 files, WAV files, AIFF files, and the like. Such files are readily exchanged between users. This phenomenon has been a driving force behind the success of web sites such as “Napster,” which facilitates the exchange of audio files between users. Such ready ability to exchange audio files, however, has also made piracy of copyrighted audio material easier. “Napster,” for example, has been the subject of recent, highly-publicized copyright infringement litigation.

What makes downloadable audio files so readily pirated is the fact that whenever an audio file is downloaded, a copy of the file is made on the downloading computer. In a perfect scenario (from the copyright owner's perspective), a user who legitimately downloads an audio file from an authorized site will transfer the audio content from the audio file onto a audio compact disc or other suitable tangible format, then delete the downloaded audio file. The presence of the audio file on the computer's hard drive, however, makes it easy and tempting to illegally exchange the file with others.

Thus, what is needed is a method of directly downloading an audio file to a tangible format without creating an exchangeable copy on a downloading computer.

### SUMMARY OF THE INVENTION

Accordingly, the present invention is directed towards a method, computer program product, and data storage device for directly downloading data (including audio or video data) from a server in a network to a network-connected storage device, bypassing any unencrypted transmission through computer system with which the storage device may be associated, so that copies of the data are not as readily made. A computer sends a request to a server to download the particular data to a particular storage device. The server contacts the storage device directly through the network to initiate the transfer. The server and storage device communicate over an encrypted data channel so as to prevent any third party, including the aforementioned computer, from intercepting and storing the transmitted data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which the processes of the present invention may be implemented;

FIG. 2A is a block diagram of a computer in which processes of the present invention may be implemented;

FIG. 2B is a block diagram of a network storage device in which processes of the present invention may be implemented;

FIG. 3 is a diagram depicting the negotiation of a Secure Sockets Layer (SSL) connection in accordance with a preferred embodiment of the present invention;

FIG. 4 is a flowchart representation of a process of sending a data file from a server to a network storage device in accordance with a preferred embodiment of the present invention; and

FIG. 5 is a flowchart representation of a process of receiving a data file by a network storage device from a server in accordance with a preferred embodiment of the present invention.

### DETAILED DESCRIPTION OF THE PREFERRED EMBODIMENT

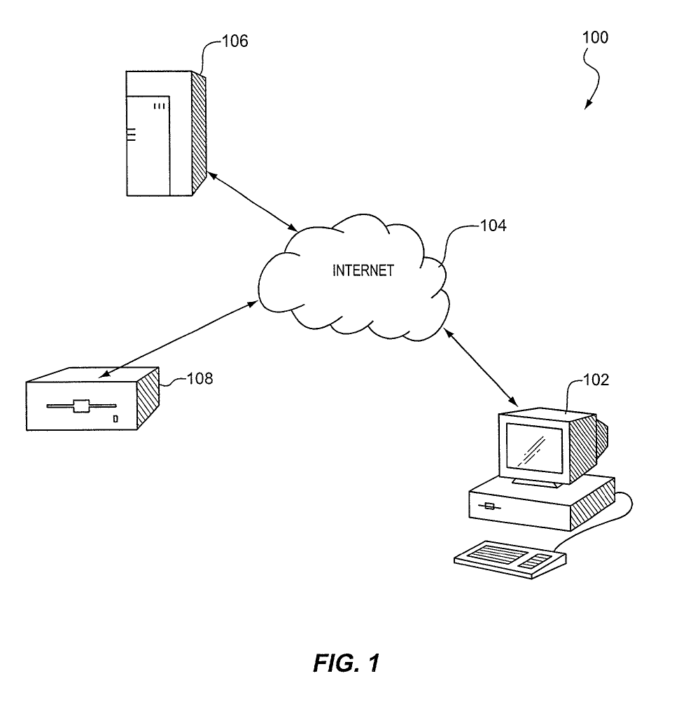

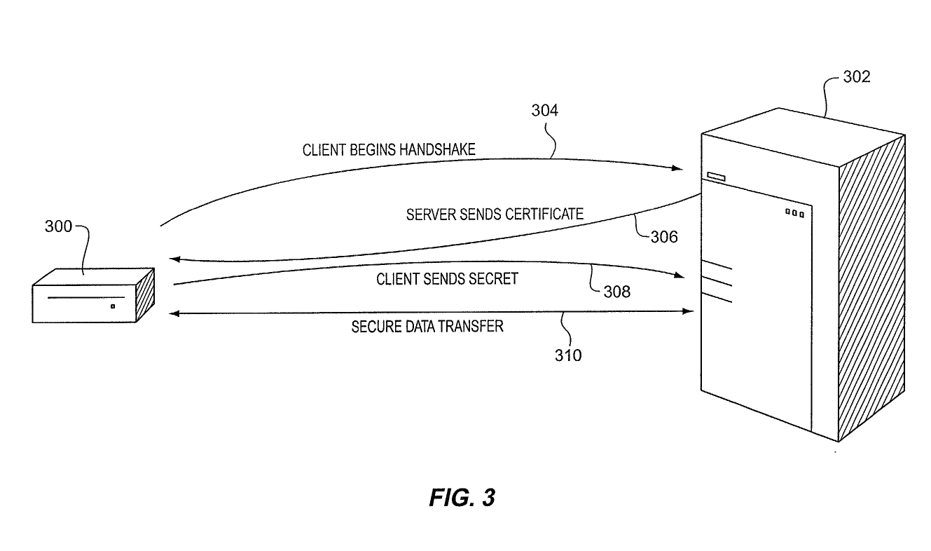

FIG. 1 depicts a distributed data processing system 100 in which the processes of the present invention may be implemented. Computer 102 connects to Internet 104, through which computer 102 communicates with server 106 and network storage device 108. In an embodiment of the present invention, computer 102 requests from server 106 that a particular item of data, such as an audio file, be downloaded from server 106 to network storage device 108. In fulfillment of the request, server 106 contacts network storage device 108 directly and sends the data over an encrypted communications channel to network storage device 108. In a preferred embodiment, the encrypted communications channel is established by means of the Secure Sockets Layer (SSL) protocol, described in more detail in FIG. 3, although any one of a number of different encryption schemes and protocols could be used.

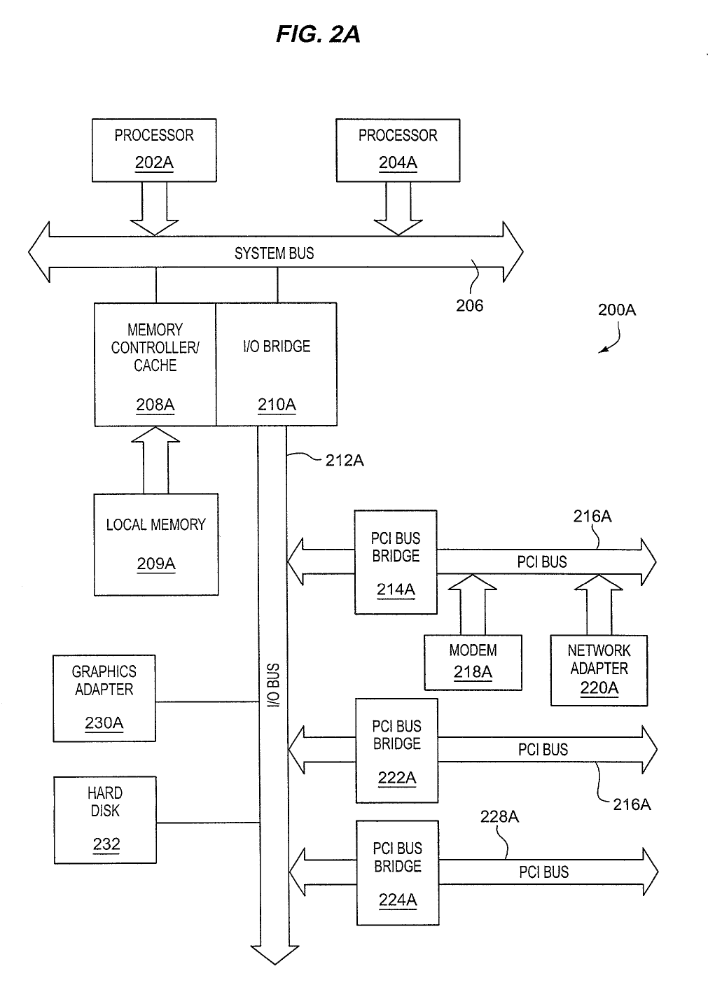

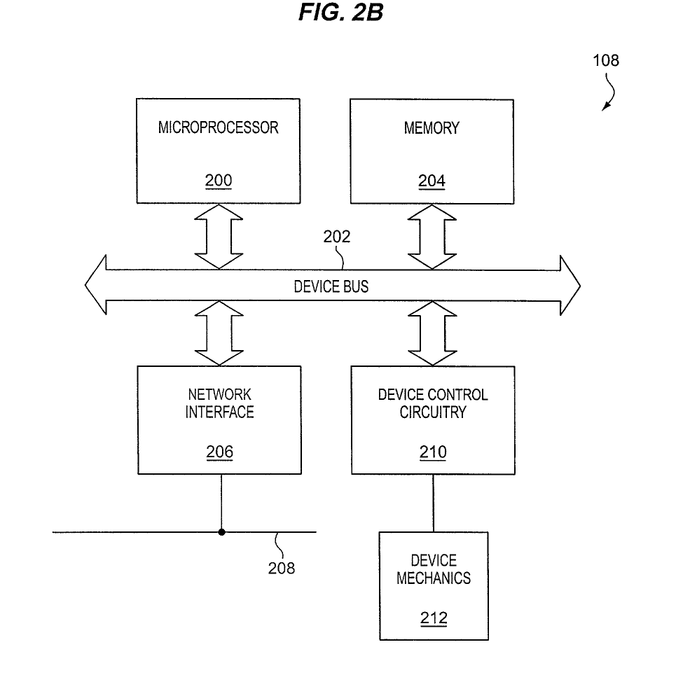

With reference now to FIG. 2A, a block diagram of a data processing system is shown in which a portion of the present invention may be implemented. Data processing system 200A is an example of a computer in which code or instructions implementing processes of the present invention may be located. Data processing system 200A employs a peripheral component interconnect (PCI) local bus architecture. Although the depicted example employs a PCI bus, other bus architectures such as Accelerated Graphics Port (AGP) and Industry Standard Architecture (ISA) may be used. Processor 202A and main memory 204A are connected to PCI local bus 206A through PCI bridge 208A. PCI bridge 208A also may include an integrated memory controller and cache memory for processor 202A. Additional connections to PCI local bus 206A may be made through direct component interconnection or through add-in boards. In the depicted example, local area network (LAN) adapter 210A, small computer system interface SCSI host bus adapter 212A, and expansion bus interface 214A are connected to PCI local bus 206A by direct component connection. In contrast, audio adapter 216A, graphics adapter 218A, and audio/video adapter 219A are connected to PCI local bus 206A by add-in boards inserted into expansion slots. Expansion bus interface 214A provides a connection for a keyboard and mouse adapter 220A, modem 222A, and additional memory 224A. SCSI host bus adapter 212A provides a connection for hard disk drive 226A, tape drive 228A, and CD-ROM drive 230A. Typical PCI local bus implementations will support three or four PCI expansion slots or add-in connectors.

An operating system runs on processor 202A and is used to coordinate and provide control of various components within data processing system 200A in FIG. 2A. The operating system may be a commercially available operating system such as Windows 2000, which is available from Microsoft Corporation. An object oriented programming system such as Java may run in conjunction with the operating system and provides calls to the operating system from Java programs or applications executing on data processing system 200A. “Java” is a trademark of Sun Microsystems, Inc. Instructions for the operating system, the object-oriented programming system, and applications or programs are located on storage devices, such as hard disk drive 226A, and may be loaded into main memory 204A for execution by processor 202A.

Those of ordinary skill in the art will appreciate that the hardware in FIG. 2A may vary depending on the implementation. Other internal hardware or peripheral devices, such as flash ROM (or equivalent nonvolatile memory) or optical disk drives and the like, may be used in addition to or in place of the hardware depicted in FIG. 2A. Also, the processes of the present invention may be applied to a multiprocessor data processing system.

For example, data processing system 200A, if optionally configured as a network computer, may not include SCSI host bus adapter 212A, hard disk drive 226A, tape drive 228A, and CD-ROM 230A, as noted by dotted line 232A in FIG. 2A denoting optional inclusion. In that case, the computer, to be properly called a client computer, must include some type of network communication interface, such as LAN adapter 210A, modem 222A, or the like. As another example, data processing system 200A may be a stand-alone system configured to be bootable without relying on some type of network communication interface, whether or not data processing system 200A comprises some type of network communication interface. As a further example, data processing system 200A may be a personal digital assistant (PDA), which is configured with ROM and/or flash ROM to provide non-volatile memory for storing operating system files and/or user-generated data.

The depicted example in FIG. 2A and above-described examples are not meant to imply architectural limitations. For example, data processing system 200A also may be a notebook computer or hand held computer in addition to taking the form of a PDA. Data processing system 200A also may be a kiosk or a Web appliance. The processes of the present invention are performed by processor 202A using computer implemented instructions, which may be located in a memory such as, for example, main memory 204A, memory 224A, or in one or more peripheral devices 226A-230A.

FIG. 2B is a block diagram depicting the structure of network storage device 108. A microprocessor 200B is embedded into network storage device 108 and functions as the control center for network storage device 108. Microprocessor 200B communicates through device bus 202B with memory 204B, from which it loads instructions for it to execute. Also connected to device bus 202B is a network interface 206B, which allows microprocessor 200B to send and receive data through network connection 208B, which in a preferred embodiment is connected to the Internet.

Device control circuitry 210B is connected to device bus 202B and provides an interface between microprocessor 200B and the physical storage components 212B of network storage device 108. Physical storage components 212B may store data to any of a variety of available tangible data storage media, including but not limited to, compact disc, digital versatile disc (DVD), magnetic disk, magnetic tape, optical disk, optical tape, and solid-state storage media (such as integrated circuit memory, including but not limited to static random access memory (SRAM), dynamic random access memory (DRAM), non-volatile random access memory (NVRAM), and flash memory).

FIG. 3 is a diagram depicting the operation of a secure sockets layer (SSL) interface between a network storage device 108 and a server 106. SSL allows data to be exchanged between network storage device 300 and server 302 over a conventional TCP/IP or other streaming network connection in an encrypted form without either of network storage device 300 and server 302 having any advance knowledge of cryptographic keys.

Creating and maintaining an SSL connection between network storage device 300 and server 302 requires two basic operations to be performed between the two machines. One is a handshake procedure, which must be performed at the beginning of the SSL connection, and periodically thereafter so as to increase security by periodically changing keys. The handshake procedure establishes the cryptographic keys that will be used to encrypt and decrypt information exchanged between network storage device 300 and server 302. The second procedure is the encrypted data transfer itself. The machine sending the data encrypts the data with a cryptographic key and transmits the encrypted data to the other machine, which decrypts the data with a cryptographic key (either the same one, or a different one, depending on the type of cryptography used).

SSL relies on public key cryptography to exchange cryptographic keys between machines. In a public key cryptosystem, such as the RSA cryptosystem described in U.S. Pat. No. 4,405,829, each party to the communication has two keys, a public key and a private key. The public key is used to encrypt messages. The encrypted messages can only be decrypted using the corresponding private key. In a public key cryptosystem, the parties exchange public keys, but keep the private keys secret. In this way, each of the parties can encrypt messages to send to the other party, and only the intended recipient will be able to decrypt the message. Note that public keys need not be exchanged in any secure way, since a public key by itself is not enough to recover an encrypted message.

As an example, suppose that two parties wish to use public-key cryptography to communicate through electronic mail. First, the parties each generate a public-private key pair. Next, the parties send each other their public keys through electronic mail (which may be intercepted by a third party), but keep their private keys secret. Then, if one of the parties wishes to send an encrypted message to the other, the sending party uses the recipient party's public key to encrypt the message before transmission. The recipient party can then use its private key to recover the original message.

In contrast to public key cryptography, conventional block ciphers, such as DES (data encryption standard), described in U.S. Pat. No. 3,962,539, use a single key for encryption and decryption. For a conventional cipher such as DES to be effective, both parties must be in possession of the same key. It follows that such key must be communicated between the parties in some secure fashion.

SSL may make use of either public-key or conventional cryptography when securely transmitting data. In either case, however, the keys are established between the parties by using a public-key cryptosystem. The public-key cryptosystem establishes a secure communications channel for exchanging a conventional cryptographic key, which can then be used to perform the bulk of the data encryption and decryption thereafter. This scheme, in which a public-key cryptosystem is used to establish a conventional cryptographic key, is advantageous in that the secure key exchange ability of public-key cryptography is coupled with the speed and enhanced security of a conventional cryptosystem. (The RSA algorithm, for instance, has the unfortunate property of periodically failing to produce an encrypted result-in other words, if the original message is “foo,” there is a probability that the RSA-encrypted version will also read “foo.” See Blakley and Borosh, Rivest-Shamir-Adleman Public Key Cryptosystems Do Not Always Conceal Messages, Comp. & Maths. With Appls., Vol. 5, pp. 169-178 (1979).)

Turning now to FIG. 3, network storage device 300 initiates (304) the handshake procedure with server 302 in response to server 302's initial contact with network storage device 300 for the purpose of establishing a download connection. In reply, server 302 returns a certificate (306) to network storage device 300. The certificate contains information about the identity of the server and also contains a public key of the server. Network storage device 300 can then verify the identity of server 302 by inspecting the certificate. Network storage device 300 generates a “master secret,” which is a piece of information (usually some kind of random or pseudo-random number) that can be used to derive cryptographic keys. Network storage device 300 uses server 302's public key to encrypt the master secret and sends (308) the secret to server 302. Server 302 uses its private key to decrypt the master secret. At this point, both network storage device 300 and server 302 are in possession of the same master secret.

Master secret can then be used as a “seed” for network storage device 300 and server 302 to use to generate cryptographic keys. Many cryptosystems make use of random numbers as an input to key-generation algorithms; thus, the master secret may be used as a random number in such algorithms. How many keys are generated and how those keys are generated is dependent on what type of encryption will be used for data transmission.

Although SSL must rely on some form of public-key cryptography in its handshake procedure, SSL may use any of a number of cryptosystems (called “cipher suites” in SSL parlance) for data transmission. Cipher suites supported by SSL include DES (data encryption standard), 3DES (triple DES), DSA (digital signature algorithm), KEA (key exchange algorithm), MD5 (message digest algorithm 5), RC2 (Rivest cipher 2), RC4 (Rivest cipher 4), RSA (Rivest, Shamir, and Adleman) public-key algorithm, RSA key exchange, SHA-1 (secure hash algorithm), and SKIPJACK. Note that some of these cipher suites are suitable for handshaking, while others are suitable for data transmission. RSA is commonly used for handshaking, and RC4 is commonly used for data transmission, for example.

Once keys have been established between network storage device 300 and server 302, the keys may be used to encrypt and decrypt information transmitted (310) between network storage device 300 and server 302. Periodically, the handshake procedure will be repeated so as to establish a new set of cryptographic keys. Periodically changing keys enhances security, because it lowers the amount of information transmitted using any one key. A cipher becomes easier to break, the more encrypted information a cryptanalyst has access to. Periodically changing keys ensures that only a small amount of information is encrypted with any one cipher.

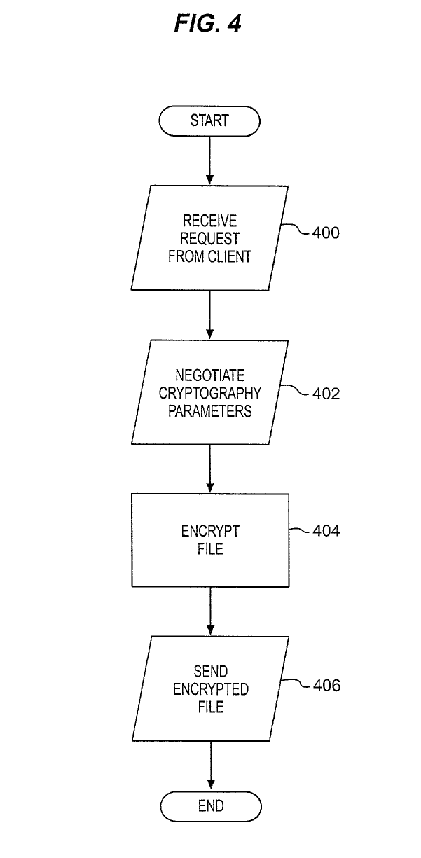

FIG. 4 is a flowchart representation of a process of sending a data file from a server to a network storage device in accordance with a preferred embodiment of the present invention. First, a request for downloading of a file is received by the server from a client computer (step 400). Next, the server contacts the network storage device and negotiates an encrypted communications channel using SSL or a similar encryption system (step 402). The negotiated cryptographic scheme is used to encrypt the file (step 404). Finally, the file is sent, via the network, to the network storage device (step 406).

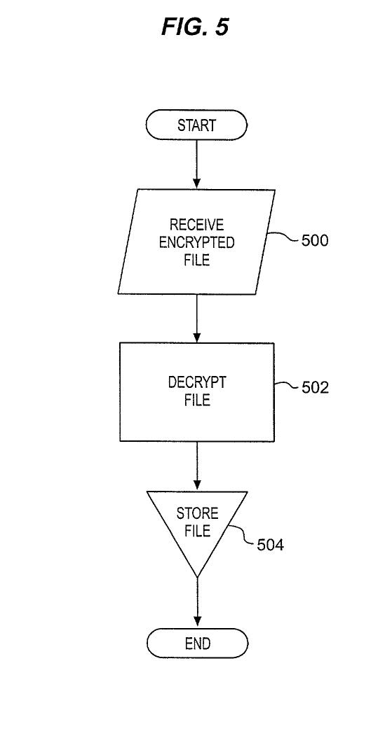

FIG. 5 is a flowchart representation of a process of receiving a data file by a network storage device from a server in accordance with a preferred embodiment of the present invention. First, the encrypted file is received by the network storage device (step 500). The file is decrypted by the network storage (step 502). Finally, the network storage device stores the file (step 504). It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as disk (e.g. disk or disc), tape, solid state, probe, volumetric (e.g. holographic), and transmission-type media, such as digital and/or analog communications links, wired and/or wireless communications links using transmission forms, such as, for example, radio frequency, infrared, and light wave transmissions. The computer readable media may take the form of coded formats that are decoded for actual use, execution, or consumption in a particular data processing or data presentation system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of transmitting data in a network comprising:
receiving from a client a request to transmit the data;
encrypting the data; and
transmitting the data to a storage device connected to the network.

2. The method of claim 1, further comprising:
negotiating encryption parameters.

3. The method of claim 2, wherein the step of negotiating encryption parameters includes establishing an encrypted communications channel.

4. The method of claim 3, wherein the encrypted communications channel is a Secure Sockets Layer (SSL) channel.

5. The method of claim 1, wherein the data includes at least one of audio data, video data, and digital data.

6. The method of claim 1, wherein the storage device stores the data in a removable medium.

7. The method of claim 6, wherein the removable medium is one of a compact disc (CD) and a digital versatile disc (DVD).

8. The method of claim 6, wherein the removable medium is one of a tape cartridge and a tape cassette.

9. The method of claim 6, wherein the removable medium is one of a holographic disc and a holographic cube.

10. The method of claim 1, wherein the storage device is one of a tape drive and a disk drive.

11. The method of claim 1, wherein the storage device is a solid-state storage device.

12. The method of claim 1, wherein the storage device is independent of the client.

13. A method, operative in a storage device, of downloading data from a server:
receiving from the server a request for downloading;
receiving an encrypted data transmission;
decrypting the encrypted data transmission to yield the data; and
storing the data.

14. The method of claim 13, further comprising negotiating encryption parameters.

15. The method of claim 14, wherein the step of negotiating encryption parameters includes performing a Secure Sockets Layer handshake.

16. The method of claim 13, wherein the data includes at least one of audio data, video data and digital data.

17. The method of claim 13, wherein the storage device is a compact disc writer.

18. The method of claim 13, wherein the storage device is one of a tape drive and a disk drive.

19. A computer program product in a computer-readable medium for transmitting data in a network, comprising instructions for:
receiving from a client a request to transmit the data;
encrypting the data; and
transmitting the data to a storage device connected to the network.

20. The computer program product of claim 19, comprising additional instructions for:
negotiating encryption parameters.

21. The computer program product of claim 20, wherein the instructions for negotiating encryption parameters include instructions for establishing an encrypted communications channel.

22. The computer program product of claim 21, wherein the encrypted communications channel is a Secure Sockets Layer (SSL) channel.

23. The computer program product of claim 19, wherein the data includes at least one of audio data, video data, and digital data.

24. The computer program product of claim 19, wherein the storage device stores the data in a removable medium.

25. The computer program product of claim 24, wherein the removable medium is one of a compact disc (CD) and a digital versatile disc (DVD).

26. The computer program product of claim 24, wherein the removable medium is one of a tape cartridge and a tape cassette.

27. The computer program product of claim 24, wherein the removable medium is one of a holographic disc and a holographic cube.

28. The computer program product of claim 19, wherein the storage device is one of a tape drive and a disk drive.

29. The computer program product of claim 19, wherein the storage device is a solid-state storage device.

30. The computer program product of claim 19, wherein the storage device is independent of the client.

31. An embedded processor program in a embedded processor-readable medium and operative in a storage device, of downloading data from a server, comprising instructions for:
receiving from the server a request for downloading;
receiving an encrypted data transmission;
decrypting the encrypted data transmission to yield the data; and
storing the data.

32. The embedded processor program of claim 31, further comprising instructions for:
negotiating encryption parameters.

33. The embedded processor program of claim 32, wherein the instructions for negotiating encryption parameters include instructions for establishing an encrypted communications channel.

34. The embedded processor program of claim 33, wherein the encrypted communications channel is a Secure Sockets Layer (SSL) channel.

35. The embedded processor program of claim 31, wherein the data includes at least one of audio data, video data, and digital data.

36. The embedded processor program of claim 31, wherein the storage device stores the data in a removable medium.

37. The embedded processor program of claim 36, wherein the removable medium is one of a compact disc (CD) and a digital versatile disc (DVD).

38. The embedded processor program of claim 24, wherein the removable medium is one of a tape cartridge and a tape cassette.

39. The embedded processor program of claim 24, wherein the removable medium is one of a holographic disc and a holographic cube.

40. The embedded processor program of claim 31, wherein the storage device is one of a tape drive and a disk drive.

41. The embedded processor program of claim 31, wherein the storage device is a solid state storage device.

42. A data processing system for transmitting data in a network, comprising:
a bus system;
a processing unit connected to the bus system, wherein the processing unit includes at least one processor;
memory connected to the bus system;
a network adapter in communication with the network and with the bus system; and
a set of instructions in the memory, wherein the processing unit executes the set of instructions to perform the acts of:
receiving with the network adapter and from a client a request to transmit the data;
encrypting the data; and
transmitting the data to a storage device connected to the network.

43. The data processing system of claim 42, wherein the storage device is independent of the client.

44. A storage device comprising:
a bus system;
an embedded processor unit connected to the bus system, wherein the embedded processor includes at least one embedded processor;
memory connected to the bus system;
a network adapter connected to the bus system;
physical storage components in communication with the bus system; and
a set of instructions in the memory, wherein the embedded processor unit executes the set of instructions to perform the acts of:
receiving with the network adapter and from the server a request for downloading;
receiving an encrypted data transmission;
decrypting the encrypted data transmission to yield the data; and
storing the data with the physical storage components.

45. The storage device of claim 44, wherein the physical storage components store the data to a removable medium.

46. The storage device of claim 44, wherein the removable medium is one of a compact disc and a digital versatile disc (DVD).

47. The storage device of claim 44, wherein the removable medium is one of a tape cartridge and a tape cassette.

48. The storage device of claim 44, wherein the removable medium is one of a holographic disc and a holographic cube.

49. The storage device of claim 44, wherein the physical storage components store the data to one of tape and a disk.

50. The storage device of claim 44, wherein the physical storage components store the data to a solid-state device.
